(19) United States
(12) Patent Application Publication
(10) Pub. No.: US 2007/0013146 A1
(43) Pub. Date: Jan. 18, 2007

(54) Sealing ring and method

(76) Inventor: James A. Gariepy, Houston, TX (US)

Correspondence Address: Browning Bushman P.C.;Suite 1800, 5718 Westheimer, Houston, TX, 77057-5771, US

(21) Appl. No.: 11/181,230

(22) Filed: Jul. 14, 2005

(51) Int. Cl. F16L 17/06

(52) U.S. Cl. 277/608

(57) ABSTRACT

A sealing ring 10 is provided for sealing between truncated conical surfaces of adjoining members 72, 74 each having a central bore therein. The sealing ring 10 includes an annular metal seal body 12 having first and second truncated conical surfaces each for planar engagement with a truncated conical surface on a respective member, and annular sealing ring insert 20, 22, 42, 60, 68 each within a radially inward recess in a respective one of the truncated conical body surfaces. Prior to sealing, the sealing ring insert includes one or more ribs 24, 44, 64, and one or more recesses 26, 48, 62. The one or more ribs when compressed deform but do not extend beyond the respective one of the body surfaces.

### FIELD OF THE INVENTION

The present invention relates to sealing rings of a type suitable for sealing between oilfield members, including tubular members, hubs, and mandrels. More particularly, the invention relates to a composite sealing ring having an annular metal seal body and a sealing ring insert. The sealing ring insert is particularly suitable for sealing with damaged sealing surfaces on one or both members.

### BACKGROUND OF THE INVENTION

Sealing rings are commonly used in the hydrocarbon recovery industry to seal between joined tubular members. These seal rings are available in a variety of configurations, such as AX, BX, CX, DX, RX, and VX. Sealing rings typically have a pair of opposing conical sealing surfaces for sealing under high contact stress with mating sealing surfaces on the tubular members. The sealing members are energized by drawing the tubular members together under high loads to deform and load the sealing surfaces. The high contract stresses provide a tight seal for sealing high pressure fluid, such as oil and gas.

The sealing ring body, which may also be referred to as a gasket body, are commonly made from either a low carbon or low alloy steel that lacks corrosion resistance, or a corrosion resistant steel such as stainless steel or nickel based corrosion resistant alloy (CRA). A particular difficult sealing situation is created when a sealing ring is intended for sealing with a worn surface on one or both members, which may have corrosion pits or scratches in the sealing surface of the members, or scale or other material buildup on the sealing surface of the member.

Sealing rings are disclosed in U.S. Pat. Nos. 5,103,915 and 6,409,176. Each of these patents disclose tubular assemblies including both primary and secondary sealing surfaces. Secondary sealing surfaces are provided for sealing when the primary sealing surfaces become damaged. These sealing rings offer a fairly expensive solution to the problem, since the sealing ring profiles are complex and have a high manufacturing cost. The equipment sealed by the seal ring, such as a wellhead or connector, also has to be fabricated with dual surface profiles. A seal ring with dual sealing surfaces may have an extended life compared to some equipment with a single sealing surface, but reliable sealing with a scratched or unscratched single sealing surface is desired. It is accordingly preferable to increase the reliability of sealing rings having only a primary sealing surface, rather than having to rely on the more complicated and expensive sealing rings having both primary and secondary sealing surfaces.

The disadvantages of the prior art are overcome by the present invention, and an improved sealing ring and method are hereinafter disclosed having high sealing reliability, particularly when sealing on a damaged surface.

### SUMMARY OF THE INVENTION

In one embodiment, a sealing ring is provided for sealing between truncated conical surfaces of adjoining members, such as tubular members, hubs, or mandrels. The sealing ring includes an annular metal seal body having a body central bore and first and second truncated conical body surfaces each for substantially planar engagement with a truncated conical member surface on a respective member. An annular sealing ring insert is provided within a radially inward recess in a selected one or both of the truncated conical body surfaces. Prior to sealing, the sealing ring insert includes one or more ribs each extending radially outward of the selected one of the body surfaces, and is formed from one of the plastic material and metal material softer than the metal seal body. One or more recesses each adjacent at least one rib extend radially outward of the selected one of the body surfaces. A recess volume of the one or more recesses is substantially equal to or greater than, and is less than 120 percent greater than, a rib volume of the one or more ribs, such that the one or more ribs on the sealing ring insert do not extend beyond the selected one of the body surfaces when the sealing ring insert is sealed with the respective member.

In another embodiment, a backup groove and elastomeric seal may be provided radially outward of the recess in sealing ring insert. The sealing ring insert may include two or more ribs and two or more recesses. The sealing ring insert may be formed from an alloy of silver, tin, lead, or indium, or may include a radially inward base and one or more ribs each formed from a fluropolymer or an elastomer. A similar sealing ring may be provided on the other body surface of the metal seal body.

According to one embodiment of the method of the invention, sealing between truncated conical surfaces of adjoining members involves positioning an annular metal seal body having first and second truncated conical body surfaces each for substantially planar engagement with a truncated conical member surface on a respective member. An annular sealing ring insert is positioned within a radially inward recess in a selected one of the body surfaces, with a sealing ring insert formed from one of a plastic material and a metal softer than the metal seal body. Prior to sealing, the sealing ring insert includes one or more ribs extending radially outward of a selected one of the body surfaces, and one or more recesses each adjacent at least one rib and extending radially inward of the selected one of the body surfaces. A recess volume of the one or more recesses is substantially equal to or greater than, and is less than 120 percent greater than, a rib volume of the one or more ribs, such that the one or more ribs do not extend beyond the selected one of the body surfaces when the sealing ring insert is sealed with the respective member.

These and further features and advantages of the present invention will become apparent from the following detailed description, wherein reference is made to the figures in the accompanying drawings.

### BRIEF DESCRIPTION OF THE DRAWINGS

FIG. 1 illustrates one embodiment of a sealing ring for sealing between first and second members.

FIG. 2 illustrates the sealing ring as shown in FIG. 1 in sealing engagement with first and second members.

FIG. 3 illustrates an alternative sealing ring, with the top half of the ring spaced from a sealing surface, and the bottom half of the sealing ring in sealing engagement with the sealing surface.

FIG. 4 illustrates another embodiment of a sealing ring, with the top half of the sealing ring spaced from a sealing surface, and the bottom half of the ring in sealing engagement with the sealing surface.

### DETAILED DESCRIPTION OF PREFERRED EMBODIMENTS

The sealing ring disclosed herein may be used for joining tubulars used in the hydrocarbon recovery industry. The sealing ring may be applied more generally in other situations and environments where first and second members are to be sealingly joined. In most embodiments, each member will have a bore therein. In some embodiments, the second body may simply be an end flange and the sealing ring may seal between a first tubular member and the end flange. Each of these members may be in the form of a flange, hub, or mandrel having a central bore therein.

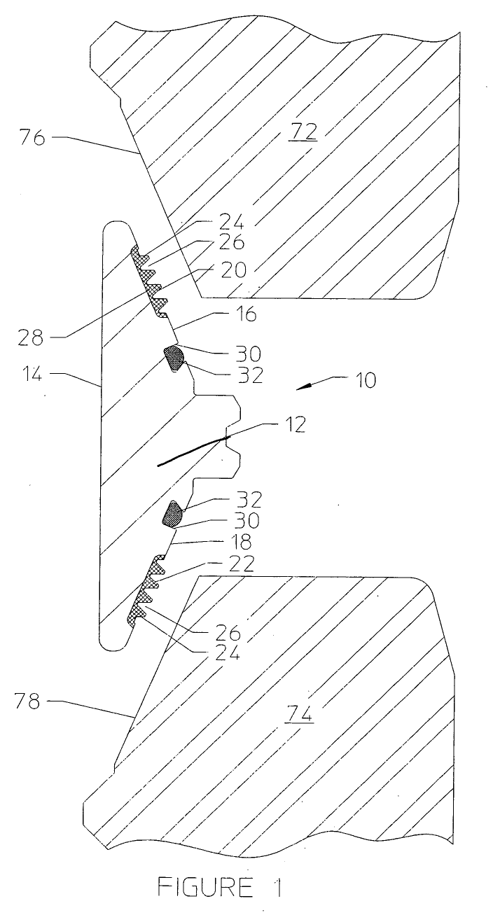

FIG. 1 illustrates one embodiment of a sealing ring for sealing between truncated conical surfaces of adjoining members each having a central bore therein, with a cross section of a member illustrating a sealing surface along a straight tapered line. The sealing ring 10 includes an annular metal seal body 12 having a radially inward surface 14 which defines a central bore through the sealing ring. The metal seal body also includes a first truncated conical body surface 16 and a second truncated conical body surface 18 each for substantially planar engagement with a respective truncated conical surface 76, 78 on a respective member 72, 74. Each body surface 16, 18, like the respective surface 76, 78, in cross section lies along a straight line with a taper substantially coinciding with the taper of the surface 76, 78.

The sealing ring includes a first annular sealing ring insert 20 and a second annular sealing ring insert 22 each provided within a radially inward recess in one of the respective body surfaces 16, 18. As shown in FIG. 1, each sealing ring insert 20, 22 prior to sealing includes one or more ribs 24 each extending radially outward of the truncated conical body surface 16, 18, with the rib being formed from either a plastic material or a material softer than the metal seal body 12.

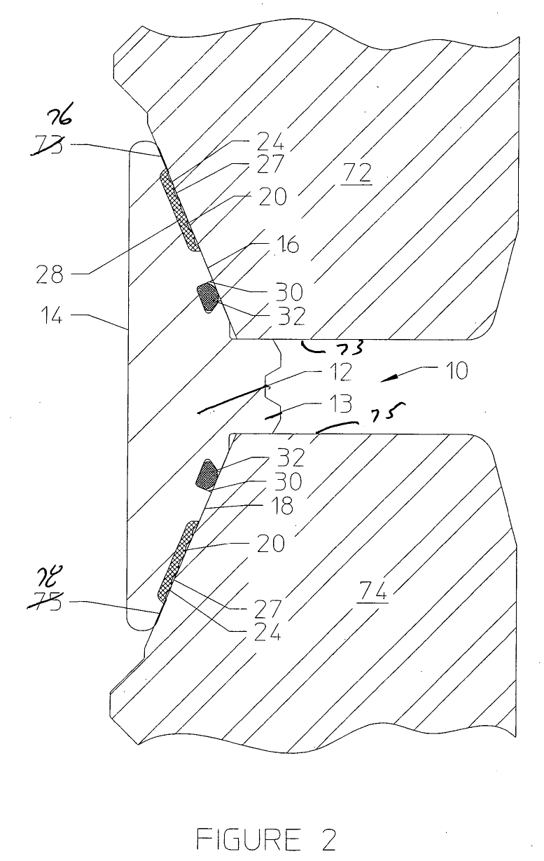

The sealing ring insert further includes one or more recesses 26 each adjacent at least one rib 24 and extending radially inward from the respective body surface 16, 18. The volume of the one or more recesses 26 extending radially inward of the selected body surface is substantially equal to or greater than, and is preferably less than 120 percent greater than, a rib volume of the one or more ribs extending radially outward of the respective one of the body surfaces. This feature allows the one or more ribs on the sealing ring insert not to extend beyond the selected one of the body surfaces when the sealing ring insert is sealed between the respective members, as shown in FIG. 2. The volume of the recesses is sufficient to absorb the volume of the ribs when the surface engaged by the sealing does or does not have a scratch or dent, or when there is a raised upset on the sealing surface. As discussed below, the preferred volume of one or more recesses in various applications will be less than 110 percent greater than the volume of the one or more ribs.

For the embodiment as shown in FIG. 1, each insert comprises a base 28 which extends substantially along the length of the recess in the body 12, and a plurality of ribs 24, with the base 28 and the ribs 24 being formed from a homogenous material. For the embodiment as shown in FIG. 1, a preferred material is a soft metal inlay which is welded into the recess, and is machined to form the angular ribs with a relatively fine pitch and the recesses 26. The sealing ring insert may thus be formed from a group consisting of an alloy of silver, tin, lead, and indium. The inclusive angle of the triangular shaped ribs is from about 30 degrees to about 50 degrees, and a plurality of ribs extend along the length of the groove in each surface 16, 18. For the embodiment as shown in FIGS. 1 and 2, the sealing ring includes two or more spaced ribs 24 and two or more recesses 26.

FIG. 1 also depicts a backup groove 30 radially inward of the respective surface 16, 18 on the metal seal body and radially outward of the recess containing the inserts 20, 22. An elastomeric seal 32 within each groove 30 provides a backup to the primary seal formed by the insert. The backup seal 32 provides a secondary or backup seal to the primary seal formed by each insert, and also facilitates testing of the metal seal ring.

As shown in FIG. 2, the sealing ring 10 is in sealing engagement with both members 72 and 74. Each of the ribs 24 is compressed at its tip, thereby partially filling the recesses 26, but preferably leaving small sized recesses 27 which are not filled. For each of the embodiments disclosed, the radially outward extending flange 13 on each sealing ring is sandwiched between surfaces 73 and 75 on the members 72, 74 when the circumferential bolts holding the members together are torqued to the desired level. Flange 13 is attached to the body 12, and preferably is integral with and of a material homogenous with the body 12. Alternatively, the flange 13 could be fabricated then secured by a press fit to the body 12.

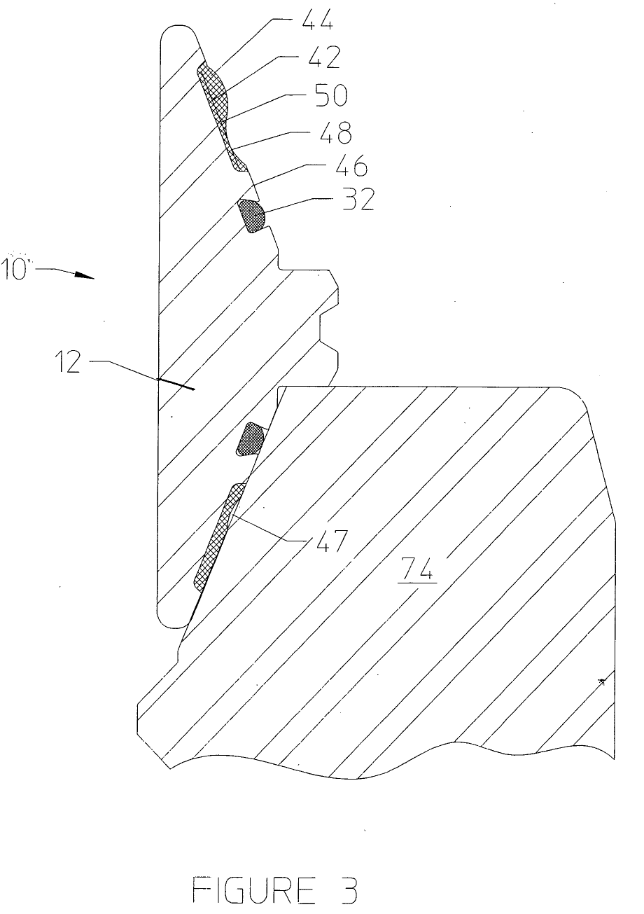

Referring now to FIG. 3, an alternative sealing member 10 includes a metal body 12 and a soft metal inlay 42 forming a single rib 44 extending from the planar surface 46, and a single recess 48 downstream from the rib 44. The backup seal 32 is provided as with FIG. 1 embodiment. For this embodiment, the base 50 of a sealing ring insert is a substantially homogenous material with the rib 44, and this combination may be formed from a metal inlay welded into a groove on the body 12, and then machined to have the configuration as shown in FIG. 3. The inlay 42 could be formed from silver, tin, lead or indium, or alternatively from a plastic material. FIG. 3 also depicts the lower half of the sealing ring in sealing engagement with member 74, with a reduced cavity 49 not filled by the deformed inlay 42. The recess 48 is desirably downstream from the rib 44, so that fluid pressure causes the inlay material to deform toward the recess 48 when the seal ring is assembled between the members 72 and 74.

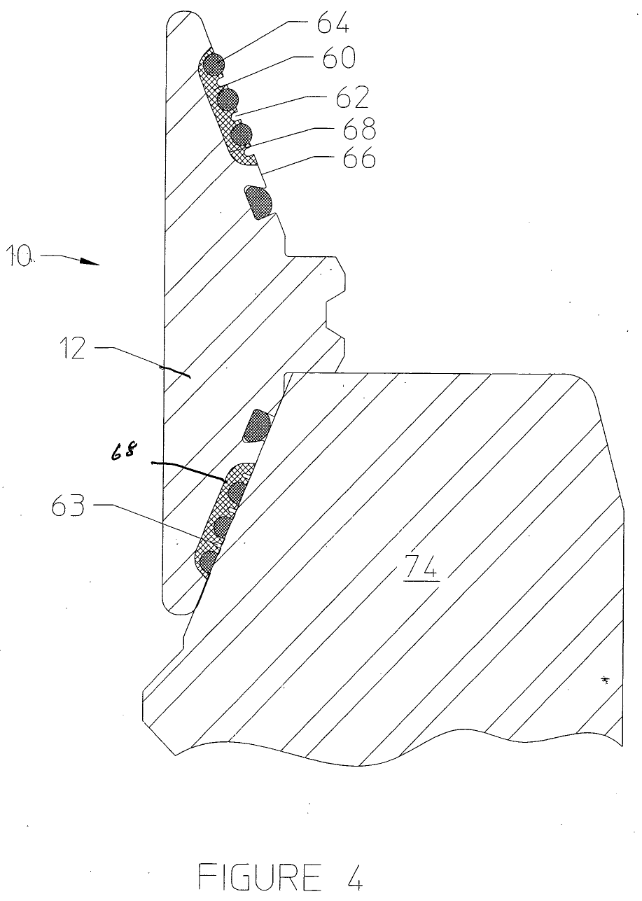

In the FIG. 4 embodiment, the body 12 supports a fluropolymer material 68 which forms both the base 60 and preferably a plurality of recesses 62. O-rings 64 formed from a molded elastomer material are supported on the base 68, with each O-ring defining a respective radially extending rib extending from the surface 66. FIG. 4 also depicts the sealing ring 10 sealed to the lower body or member 74. The compressed O-rings 64 deform the plastic material 60, reducing the size of the manufactured cavities 62 to form reduced sized cavities 63. A suitable plastic material is a fluoropolymer, and the recess 62 is again provided downstream of a respective rib 64.

The protruding ribs of the sealing ring are able to reliably reach the bottom of a scratch or dent in the planar member surface engaged by the sealing ring, and thereby reliably seal with the scratch or dent surface of a member. The ribs are formed from the material which is sufficiently elastic to conform with the fine contours of the scratch or dent, while also being able to reliably seal with this sealing surface if there is no scratch or dent, or if the sealing surface has a raised upset.

For each of the embodiments discussed above, the volume of the one or more recesses in the insert extends radially inward of the planar seal body surface in which the recess is formed which receives the insert itself. This recess volume is substantially equal to or greater than, and is less than 120% greater than, a rib volume of the one or more ribs extending radially outward of this seal body surface. The volume of the recesses in the insert is thus capable of receiving the rib volume when the seal is made up and material of the ribs flows into the recesses. If the rib volume is appreciably greater than the recess volume, the rib material may undesirably form a thin cushion separating the seal body surface from the truncated conical surface of the flange or other member. Depending on the application, the recess volume in some applications may be slightly less than the rib volume, e.g., may be 98 or 99% of the rib volume, but undesirable floating between the seal body and the member may be avoided if the rib material is slightly compressible, or if scratches, nicks, or abrasions on the respective member surface are able to accommodate 1 or 2% of the rib volume when the seal is made up. As indicated herein, the present invention is particularly well suited for sealing with damaged surfaces of a flange or other respective member which have scratches or pits, and if the volume of this damaged surface is substantially uniform throughout the circumference of the seal, 1 or 2% of the rib volume may desirably flow into these scratches or pits to form a reliable seal, and the remaining portion of the rib volume may be received within the recesses in the sealing ring insert while still maintaining planar engagement of the seal body surface and the mating surface of a respective flange or other member.

In many applications, a preferred volume of the one or more recesses may be less than 115% greater than the volume of the one or more ribs, and in other applications the preferred volume of the one or more recesses will be less than 110% greater than the volume of the one or more ribs. By minimizing the excess recess volume which is greater than the rib volume, the seal body maintains a desirable seal over an extended period of time, with a very low likelihood that rib material which forms the seal will “flow” or “creep” into the excess recess volume and reduce sealing effectiveness.

It should be apparent from the embodiments described that the term “rib” as used herein may be any annular member extending radially outward of the respective truncated conical body surface on the seal body. In FIG. 1, each of the ribs in cross section thus has a substantially triangular configuration, while in the FIG. 2 embodiment the single rib 44 in cross section has a relatively smooth curved surface. In the FIG. 3 embodiments, each of the radial extending ribs is a portion of an O-ring which extends outward from the respective truncated conical surface on the body.

A low carbon steel may be used to fabricate the annular metal seal body, although corrosion resistant materials such as a stainless steel are preferable for some applications. If desired, the metal seal body may be provided with a thin outer coating, typically having a thickness of from one to three thousandths of an inch, of silver, tin, molybdenum disulfide or a fluoropolymer to further reduce corrosion, reduce friction, and help prevent galling. In some embodiments, both a primary sealing surface and a backup sealing surface may be included on the sealing ring and on the members being sealed, so that if the primary sealing surface no longer seals, the backup sealing surface may be employed to seal with the members.

Various alterations will be suggested by the disclosure. For example, the seal ring may be provided with a second truncated conical surface for sealing with the member if the first truncated conical seal surface in the seal ring spaced from the second truncated conical surface should become damaged. If there is leakage past the primary sealing ring, it may be replaced by the backup or secondary sealing ring. When installing a secondary or backup sealing ring, the shoulders land and the sealing surfaces engage. Either the primary or the backup sealing surfaces on the seal body may include the insert as described herein.

The upper and lower portions of the sealing ring are configured to be flexed inwardly as the members are drawn together, thus imparting high stress to the mating surfaces on the sealing ring and the members. As the members are axially urged toward one another, a shoulder on one member may land on the shoulder of another member. After the shoulders have landed, the primary sealing surfaces of the seal ring will have engaged the sealing surfaces on the members, and may leave a slight gap axially inward of the sealing surfaces. Each of the sealing rings may or may not have ports to permit leakage of contained pressure to pass outward through adjacent ends of the member.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A sealing ring for sealing between truncated conical surfaces of adjoining members, each member having a central bore therein, the sealing ring comprising:
an annular metal seal body having a body central bore and first and second truncated conical body surfaces each for substantially planar engagement with a truncated conical member surface on a respective member;
an annular sealing ring insert within a radially inward recess in a selected one of the truncated conical body surfaces;
prior to sealing, the sealing ring insert including one or more ribs each extending radially outward of the selected one of the truncated conical body surfaces, and formed from one of a plastic material and a metal material softer than the metal seal body, and one or more of recesses each adjacent at least one rib and extending radially inward of the selected one of the truncated conical body surfaces; and
a recess volume of the one or more recesses extending radially inward of the selected one of the truncated conical body surfaces is substantially equal to or greater than, and is less than one hundred and twenty percent (120%) greater than, a rib volume of the one or more ribs extending radially outward of the selected one of the truncated conical body surfaces, such that the one or more ribs on the sealing ring insert do not extend beyond the respective one of the truncated conical body surfaces when the sealing ring insert is sealed with the respective member.

2. A sealing ring as defined in claim 1, further comprising:
a backup groove within the metal seal body radially outward of the radially inward recess and extending through the selected one of the truncated conical body surfaces; and
an elastomeric seal within the backup groove.

3. A sealing ring as defined in claim 1, wherein the sealing ring insert includes two or more ribs and two or more recesses.

4. A sealing ring as defined in claim 1, wherein the sealing ring insert is formed from a group consisting of an alloy of silver, tin, lead and indium.

5. A sealing ring as defined in claim 1, wherein the sealing ring insert includes a radially inward base and the one or more ribs, each of the base and the one or more ribs formed from a homogenous material.

6. A sealing ring as defined in claim 1, wherein the sealing ring insert includes a radially inward base formed from a fluropolymer material, and one or more ribs extending outward from the selected truncated conical body surface prior to sealing.

7. A sealing ring as defined in claim 6, wherein the one or more recesses are each provided in the base, and each of the one or more ribs is an annular member supported on and extending radially outward from the base.

8. A sealing ring as defined in claim 1, further comprising:
another annular sealing ring insert within another radially inward recess in another truncated conical body surface, the another sealing ring insert formed from one of a plastic material and a metal softer than the metal seal body;
prior to sealing, the another sealing ring insert including one or more another ribs each extending radially outward of the another truncated conical body surface, and one or more another recesses each adjacent at least one another rib and extending radially outward of the another truncated conical body surface; and
a recess volume of the one or more another recesses extending radially inward of the another truncated conical body surface is substantially equal to or greater than, and is less than one hundred and twenty percent (120%) greater than, a rib volume of the one or more another ribs extending radially outward of the another tapered body surface, such that the one or more another ribs on the another sealing ring insert do not extend beyond the another truncated conical surface when the another sealing ring insert is sealed with the respective member.

9. A sealing ring as defined in claim 1, wherein the volume of the one or more recesses is less than one hundred and ten percent (110%) greater than the rib volume of the one or more ribs.

10. A sealing ring as defined in claim 1, wherein the annular metal seal body is formed from a stainless steel.

11. A sealing ring as defined in claim 1, wherein during assembly a radially outward flange secured to the metal seal body engages a planar flange engaging surface on a respective member.

12. A sealing ring for sealing between truncated conical surfaces of adjoining members, each flange having a central bore therein, the sealing ring comprising:
an annular metal seal body having a body central bore and first and second truncated conical body surfaces each for substantially planar engagement with a truncated conical member surface on a respective member;
an annular sealing ring insert within a radially inward recess in a selected one of the truncated conical body surfaces, the sealing ring insert formed from a group consisting of an alloy of silver, tin, lead, and indium, and a plastic material;
prior to sealing, the sealing ring insert including a radially inward base and at least two ribs each extending radially outward of the selected one of the truncated conical body surfaces, and at least two recesses each adjacent at least one rib and extending radially inward of the selected one of the truncated conical body surfaces; and
a recess volume of the at least two recesses extending radially inward of the selected one of the truncated conical body surfaces is substantially equal to or greater than, and is less than one hundred and twenty percent (120%) greater than, a rib volume of the at least two ribs extending radially outward of the respective one of the truncated conical body surfaces, such that the at least two ribs on the sealing ring insert do not extend beyond the selected one of the truncated conical body surfaces when the sealing ring insert is sealed with the respective member.

13. A sealing ring as defined in claim 12, wherein the sealing ring insert includes a radially inward base formed from a fluropolymer material, and one or more ribs extending outward from the selected truncated conical body surface prior to sealing.

14. A sealing ring as defined in claim 12, wherein the one or more recesses are each provided in the base, and each of the one or more ribs is an annular member supported on and extending radially inward from the base.

15. A sealing ring as defined in claim 12, further comprising:
a backup groove within the metal seal body radially outward of the radially inward recess and extending to the selected one of the truncated conical body surfaces; and
an elastomeric seal within the backup groove.

16. A sealing ring as defined in claim 12, further comprising:
another annular sealing ring insert within another radially inward recess in another truncated conical body surface, the another sealing ring insert formed from one of a plastic material and a metal softer than the metal seal body;
prior to sealing, the another sealing ring insert including at least two another ribs extending radially outward of the another truncated conical body surface, and at least two another recesses each adjacent at least one another rib and extending radially outward of the another truncated conical body surface; and
a recess volume of the at least two another recesses extending radially inward of the another truncated conical body surface is substantially equal to or greater than, and is less than one hundred and twenty percent (120%) greater than, a rib volume of the at least two another ribs extending radially outward of the another tapered body surface, such that the at least two another ribs on the another sealing ring insert do not extend beyond the another truncated conical surface when the another sealing ring insert is sealed with the respective member.

17. A sealing ring as defined in claim 12, wherein the volume of the at least two recesses is less than one hundred and fifteen percent (115%) greater than the rib volume of the at least two ribs.

18. A sealing ring as defined in claim 12, wherein at least one of the recesses is radially outward of an adjacent rib.

19. A sealing ring as defined in claim 12, wherein the volume of the at least two recesses is less than one hundred and ten percent (110%) greater than the rib volume of the at least two ribs.

20. A method of sealing between truncated conical surfaces of adjoining members, each member having a central bore therein, the method comprising:
positioning an annular metal seal body having a body central bore and first and second truncated conical body surfaces each for substantially planar engagement with a truncated conical member surface on a respective member;
positioning an annular sealing ring insert within a radially inward recess in a selected one of the truncated conical body surfaces, the sealing ring insert formed from one of a plastic material and a metal material softer than the metal seal body;
prior to sealing, the sealing ring insert including one or more ribs extending radially outward of the selected one of the truncated conical body surfaces, and one or more recesses each adjacent at least one rib and extending radially inward of the selected one of the truncated conical body surfaces; and
a recess volume of the one or more recesses extending radially inward of the selected one of the truncated conical body surfaces is substantially equal to or greater than, and is less than one hundred and twenty percent (120%) greater than, a rib volume of the one or more ribs extending radially outward of the respective one of the truncated conical body surfaces, such that the one or more ribs on the sealing ring insert do not extend beyond the selected one of the truncated conical body surfaces when the sealing ring insert is sealed with the respective member.

21. A method as defined in claim 20, further comprising:
positioning a backup groove within the metal seal body radially outward of the radially inward recess and extending to the selected one of the planar body surfaces; and
positioning an elastomeric seal within the backup groove.

22. A method as defined in claim 20, wherein the sealing ring insert is selected from a group consisting of an alloy of silver, tin, lead, or indium, and a plastic material.

23. A method as defined in claim 20, further comprising:
positioning another annular sealing ring insert within another radially inward recess in another truncated conical body surface, the another sealing ring insert formed from one of a plastic material and a metal softer than the metal seal body;
prior to sealing, the another sealing ring insert including another radially inward base and at least one another rib extending radially outward from the another base, each another rib extending radially outward of the another truncated conical body surface, and at least one another recesses each adjacent at least one another rib and extending radially outward of the another truncated conical body surface; and
a recess volume of the at least one another recesses extending radially inward of the another truncated conical body surface is substantially equal to or greater than, and is less than one hundred and twenty percent (120%) greater than, a rib volume of the at least one another rib extending radially outward of the another tapered body surface, such that the at least one rib on the another sealing ring insert does not extend beyond the respective truncated conical surface when the sealing ring insert is sealed with the respective member.

24. A method as defined in claim 20, wherein the recess volume of the at least one recess is less than one hundred and ten percent (110%) greater than the rib volume of the at least one rib.

25. A sealing ring as defined in claim 20, wherein the sealing ring insert includes a radially inward base formed from a fluropolymer material, and one or more ribs extending outward from the selected truncated conical body surface prior to sealing.

26. A sealing ring as defined in claim 20, wherein the one or more recesses are each provided in the base, and each of the one or more ribs is an annular member supported on and extending radially outward from the base.

27. A sealing ring as defined in claim 20, wherein during assembly a radially outward flange secured to the metal seal body engages a planar flange engaging surface on a respective member.
